(19) United States
(12) Patent Application Publication
(10) Pub. No.: US 2026/0205886 A1
(43) Pub. Date: Jul. 16, 2026

(54) METHOD OF COORDINATED OPERATION IN WLAN AND ACCESS POINT DEVICE

(71) Applicant: GUANGDONG OPPO MOBILE TELECOMMUNICATIONS CORP., LTD., Dongguan (CN)

(72) Inventor: Dong Wei, Dongguan (CN)

(21) Appl. No.: 19/447,460

(22) Filed: Jan. 13, 2026

Related U.S. Application Data
(60) Provisional application No. 63/744,518, filed on Jan. 13, 2025.
(60) Provisional application No. 63/765,324, filed on Feb. 28, 2025.
(60) Provisional application No. 63/773,905, filed on Mar. 18, 2025.
(60) Provisional application No. 63/779,639, filed on Mar. 28, 2025.
(60) Provisional application No. 63/780,694, filed on Mar. 31, 2025.

(51) Int. Cl. H04W 28/18; H04W 84/12

(52) U.S. Cl. CPC H04W 28/18; H04W 84/12

(57) ABSTRACT

A method of coordinated operation performed by an access point (AP) device in a wireless local area network (WLAN) includes transmitting, to at least one other AP device, coordinate information or a negotiation request frame for multi-AP coordination (MAPC) and performing, based on a response from the at least one other AP device, a coordinated transmission operation, wherein the coordinated transmission operation includes at least one of a coordinated beamforming (Co-BF), a coordinated spatial reuse (Co-SR), or a coordinated time-division multiple access (Co-TDMA).

### CROSS REFERENCE TO RELATED APPLICATIONS

This application claims priority to U.S. Provisional Application No. 63/744,518, entitled “METHOD AND APPARATUS FOR COORDINATED BEAMFORMING WITH UNEQUAL CHANNEL BANDWIDTHS IN WIRELESS LOCAL AREA NETWORKS,” filed on Jan. 13, 2025; U.S. Provisional Application No. 63/765,324, entitled “METHOD AND APPARATUS FOR CHANNEL SOUNDING FOR COORDINATED BEAMFORMING IN WIRELESS LOCAL AREA NETWORKS,” filed on Feb. 28, 2025; U.S. Provisional Application No. 63/773,905, entitled “METHOD AND APPARATUS OF OPPORTUNISTIC MEASUREMENTS FOR COORDINATED SPATIAL REUSE IN WIRELESS LOCAL AREA NETWORKS,” filed on Mar. 18, 2025; U.S. Provisional Application No. 63/779,639, entitled “METHOD AND APPARATUS FOR COORDINATION AMONG MULTIPLE ACCESS POINTS IN WIRELESS LOCAL AREA NETWORKS,” filed on Mar. 28, 2025; and U.S. Provisional Application No. 63/780,694, entitled “METHOD AND APPARATUS FOR CHANNEL SOUNDING AND DATA TRANSMISSION IN COORDINATION BEAMFORMING AND COORDINATED SPATIAL REUSE IN WIRELESS LOCAL AREA NETWORKS,” filed on Mar. 31, 2025; each of which is incorporated herein in its entirety by reference.

### TECHNICAL FIELD

The present disclosure relates to the field of communication systems, and more particularly, to a method of coordinated operation performed by an access point (AP) device in a wireless local area network (WLAN) and an AP device.

### BACKGROUND

In wireless local area networks (WLANs), access point (AP) devices often operate with different channel bandwidths, but existing coordinated beamforming (Co-BF) techniques assume equal bandwidths and require duplicated sounding procedures. Current coordinated spatial reuse (Co-SR) schemes rely on additional measurement functionality and consume extra airtime. Existing multi-AP coordination (MAPC) mechanisms lack complete negotiation, fairness handling, and termination procedures. Channel-sounding and data-transmission sequences are fragile, as missing responses can cause the entire operation to fail.

Therefore, there is a need for apparatuses and methods of coordinated operation.

### SUMMARY

An object of the present disclosure is to propose a method of coordinated operation performed by an access point (AP) device in a wireless local area network (WLAN) and related apparatus, which can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

In a first aspect of the present disclosure, a method of coordinated beamforming performed by an access point (AP) device in a wireless local area network (WLAN) includes determining, by the AP device as an initiating AP device, a set of configurations for downlink data transmissions to selected stations, wherein the set of configurations includes at least one of a transmission channel bandwidth, a number of spatial streams per station, or a number of transmit chains.

In a second aspect of the present disclosure, a method of coordinated beamforming performed by an access point (AP) device in a wireless local area network (WLAN) includes receiving, from another AP device, a negotiation information for multi-AP coordination (MAPC) and transmitting, to the another AP device, a response indicating at least one configuration for coordinated beamforming or coordinated spatial reuse.

In a third aspect of the present disclosure, an AP device includes a memory, a transceiver, and a processor coupled to the memory and the transceiver. The AP is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a diagram illustrating an example of coordinated beamforming (Co-BF) communication between a coordinating AP and a coordinated AP according to an embodiment of the present disclosure.

FIG. 1B is a diagram illustrating an example of Co-BF communication between a coordinating AP and a coordinated AP according to an embodiment of the present disclosure.

FIG. 1C is a block diagram of one or more AP devices and one or more non-AP stations o communication in a communication network system according to an embodiment of the present disclosure.

FIG. 2 is a block diagram of one or more AP devices according to an embodiment of the present disclosure.

FIG. 3 is a block diagram of one or more AP devices according to an embodiment of the present disclosure.

FIG. 4A is a flowchart illustrating a method of coordinated operation performed by an access point (AP) device in a wireless local area network (WLAN) according to an embodiment of the present disclosure.

FIG. 4B is a flowchart illustrating a method of coordinated operation performed by an access point (AP) device in a wireless local area network (WLAN) according to an embodiment of the present disclosure.

FIG. 5 is a block diagram of an example of a computing device according to an embodiment of the present disclosure.

FIG. 6 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Some embodiments of the present disclosure provide an exemplary method by which two access point (AP) devices in a wireless local area network (WLAN) establish a mutual agreement for coordinated beamforming (COBF), enabling the AP devices to cooperatively manage downlink transmissions, mitigate interference across overlapping basic service sets (BSSs), and improve overall system efficiency and throughput.

In some embodiments of the present disclosure, the terms “coordinating access point (coordinating AP)” and “coordinated access point (coordinated AP)” follow the definitions provided in the description. In details, coordinated beamforming coordinating access point (Co-BF coordinating AP): A coordinating AP that initiates a coordinated beamforming (Co-BF) transmission with another AP. Coordinated beamforming coordinated access point (Co-BF coordinated AP): A coordinated AP that participates in a Co-BF transmission initiated by the Co-BF coordinating AP. Accordingly, in some embodiments of the present disclosure, the “initiating AP device” corresponds to the Co-BF coordinating AP, and the “responding AP device” corresponds to the Co-BF coordinated AP. In some embodiments of the present disclosure, “an initiating AP” corresponds to a coordinating AP, and “a responding AP” corresponds to a coordinated AP. These definitions are used interchangeably in some embodiments of the present disclosure to describe the functional relationship between multiple AP devices performing coordinated beamforming operations.

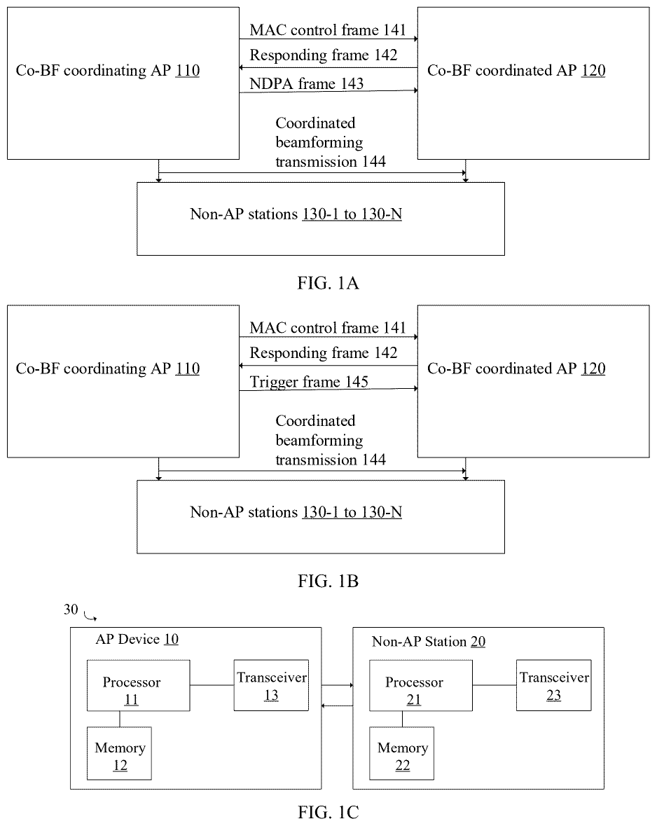

FIG. 1A illustrates an example of coordinated beamforming (Co-BF) communication between two access points (APs). In this embodiment, a Co-BF coordinating AP110, also referred to as the initiating AP device, initiates a Co-BF operation by transmitting a medium access control (MAC) control frame 141 to a Co-BF coordinated AP120, also referred to as the responding AP device. The Co-BF coordinated AP120 may transmit a responding frame 142 to indicate participation in the coordinated beamforming procedure. The Co-BF coordinating AP110 then transmits a null data packet announcement (NDPA) frame 143 to initiate a sounding operation for obtaining channel state information (CSI) from a plurality of non-AP stations 130-1 to 130-N. After acquiring CSI, both Co-BF coordinating AP110 and the Co-BF coordinated AP120 jointly perform a coordinated beamforming transmission 144 to the non-AP stations. FIG. 1A illustrates the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1B illustrates an example of coordinated beamforming (Co-BF) communication between two access points (APs). In this embodiment, a Co-BF coordinating AP110, also referred to as the initiating AP device, initiates a Co-BF operation by transmitting a medium access control (MAC) control frame 141 to a Co-BF coordinated AP120, also referred to as the responding AP device. The Co-BF coordinated AP120 may transmit a responding frame 142 to indicate participation in the coordinated beamforming procedure. The Co-BF coordinating AP110 then transmits a trigger frame 145 to initiate a sounding operation for obtaining channel state information (CSI) from a plurality of non-AP stations 130-1 to 130-N. After acquiring CSI, both Co-BF coordinating AP110 and the Co-BF coordinated AP120 jointly perform a coordinated beamforming transmission 144 to the non-AP stations. FIG. 1A and FIG. 1B illustrate the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1C illustrates that, in some embodiments, one or more AP devices 10 and non-AP stations 20 of communication in a communication network system 30 according to an embodiment of the present disclosure are provided. The communication network system 30 includes the one or more AP devices 10 and the non-AP stations 20. The one or more AP devices 10 may include a memory 12, a transceiver 13, and a processor 11 coupled to the memory 12 and the transceiver 13. The non-AP stations 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to transmit, to at least one other AP device, coordinate information or a negotiation request frame for multi-AP coordination (MAPC), and the processor is configured to perform, based on a response from the at least one other AP device, a coordinated transmission operation, wherein the coordinated transmission operation includes at least one of a coordinated beamforming (Co-BF), a coordinated spatial reuse (Co-SR), or a coordinated time-division multiple access (Co-TDMA). This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

In some embodiments, the coordinate information is carried by the negotiation request frame. In some embodiments, an initiating AP or a response AP is configured to update or teardown a MAPC agreement. In some embodiments, performing the coordinated transmission operation comprises: an initiating AP transmitting a medium access control (MAC) frame, and the MAC frame includes information with at least one of the followings: a transmission opportunity (TXOP) to be shared with the at least one other AP device, a channel bandwidth used for downlink transmission to one or more associated non-AP stations, or a number of spatial streams or transmit chains to be used for coordinated beamforming. In some embodiments, the initiating AP device and the responding AP device are specific operational roles of the AP device, and each AP device participating in the multi-AP coordination (MAPC) procedure may act as an initiating AP or a responding AP depending on the signaling flow.

In some embodiments, performing the coordinated transmission operation includes: an initiating AP transmitting a trigger frame to trigger a physical layer protocol data unit (PPDU) transmission using a channel bandwidth associated with the AP device. In some embodiments, performing the coordinated transmission operation includes: an initiating AP transmitting a null data packet announcement (NDPA) frame to trigger a unified sounding procedure for measuring channel state information (CSI) for both the AP device and the at least one other AP device. In some embodiments, during the unified sounding procedure, the AP device transmits a first null data packet (NDP) using a first number of transmit chains and receives a second NDP transmitted using a second number of transmit chains. In some embodiments, a response AP device adapts the channel bandwidth of an initiating AP, or adapts an unequal channel bandwidth of the initiating AP.

In some embodiments, the coordination information includes an indication of a transmission opportunity (TXOP) to be shared with the at least one other AP device. In some embodiments, the coordination information includes a channel bandwidth used for downlink transmission to one or more associated non-AP stations. In some embodiments, the coordination information includes a number of spatial streams or transmit chains to be used for coordinated beamforming. In some embodiments, the AP device selects one or more associated stations for coordinated beamforming prior to transmitting the coordination information. In some embodiments, performing the coordinated transmission operation includes transmitting a null data packet (NDP) or a physical layer protocol data unit (PPDU) using a channel bandwidth associated with the AP device. In some embodiments, the AP device adapts the channel bandwidth of an NDP transmission based on whether a station is associated with the AP device or with the at least one other AP device. In some embodiments, performing the coordinated transmission operation includes conducting a unified sounding procedure for measuring channel state information (CSI) for both the AP device and the at least one other AP device.

In some embodiments, during the unified sounding procedure, the AP device transmits a first NDP using a first number of transmit chains and receives a second NDP transmitted using a second number of transmit chains. In some embodiments, the coordinated transmission operation includes enabling at least one station associated with the AP device to perform opportunistic path-loss measurements of signals transmitted by the at least one other AP device. In some embodiments, the AP device transmits a trigger frame or a null data packet announcement (NDPA) frame containing an indication of transmit power to support the opportunistic path-loss measurements. In some embodiments, the coordination information includes initiating a multi-AP coordination (MAPC) negotiation including an indication of symmetrical or asymmetrical operation. In some embodiments, the coordination information includes an indication requesting the at least one other AP device to operate as a synchronization follower or synchronization reference. In some embodiments, the synchronization follower compensates a carrier frequency offset (CFO) based on the synchronization reference. In some embodiments, performing the coordinated transmission operation includes determining a reference AP device based on which AP device obtains a TXOP. In some embodiments, the method further includes transmitting, by the AP device, a termination indication to release roles or identifiers associated with a terminated MAPC agreement. In some embodiments, performing the coordinated transmission operation includes transmitting an initial control frame (ICF) to associated stations to determine availability for channel sounding or data transmission. In some embodiments, the AP device transmits an inviting frame to the at least one other AP device upon receiving at least one initial control reply (ICR) from the associated stations. In some embodiments, the AP device transmits a trigger frame to initiate physical layer protocol data unit (PPDU) transmission in response to receiving an acceptance indication from the at least one other AP device. In some embodiments, performing the coordinated transmission operation includes transmitting an initial control frame (ICF) to associated stations.

In various embodiments, an AP device transmits coordination information to at least one other AP device to establish multi-AP coordination and performs coordinated operations, including Co-BF, Co-SR, or Co-TDMA, based on a received response. The coordination information may indicate a TXOP to be shared, a channel bandwidth for downlink transmission, a number of spatial streams or transmit chains, selected stations for Co-BF, or a request for symmetrical/asymmetrical MAPC operation or CFO-related follower behavior. The coordinated operation may include unified low-overhead sounding, adaptive NDP bandwidth selection, CSI measurement using different transmit-chain configurations, opportunistic path-loss measurements supported by trigger or NDPA frames with transmit-power indication, and robust negotiation, reference-AP determination, and termination behaviors for MAPC. During sounding or data transmission, the AP device may transmit initial control frames (ICFs) to check station availability, receive initial control replies (ICRs), send inviting frames to the peer AP device, and trigger PPDU transmission upon acceptance. These embodiments collectively enable unequal-bandwidth coordinated beamforming, unified sounding, efficient Co-SR measurement opportunities, and reliable multi-AP coordination across diverse WLAN deployments.

In some embodiments, the transceiver 13 is configured to receive, from another AP device, a negotiation information for multi-AP coordination (MAPC) and transmit, to the another AP device, a response indicating at least one configuration for coordinated beamforming or coordinated spatial reuse. This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

In some embodiments, the at least one configuration includes a channel bandwidth, number of spatial streams, or number of transmit chains. In some embodiments, the response indicates whether full or partial spatial nulling is to be performed. In some embodiments, the response indicates a request for the other AP device to operate as a shared AP device during a future transmission opportunity (TXOP). In some embodiments, the AP device initiates a sounding operation when obtaining a TXOP. In some embodiments, the AP device terminates participation in coordinated beamforming or coordinated spatial reuse by transmitting a termination indication.

In some embodiments, the AP device receives multi-AP coordination negotiation information from another AP and returns a response that may include configurations such as channel bandwidth, number of spatial streams, or number of transmit chains, thereby enabling unequal-bandwidth coordinated beamforming, unified low-overhead sounding, opportunistic path-loss measurement, and robust multi-AP coordination. The response may further indicate whether full or partial spatial nulling is performed, request the other AP to act as a shared AP in a future TXOP, trigger sounding when obtaining a TXOP, or terminate participation in Co-BF/Co-SR via a termination indication, collectively improving efficiency and reliability across WLAN deployments.

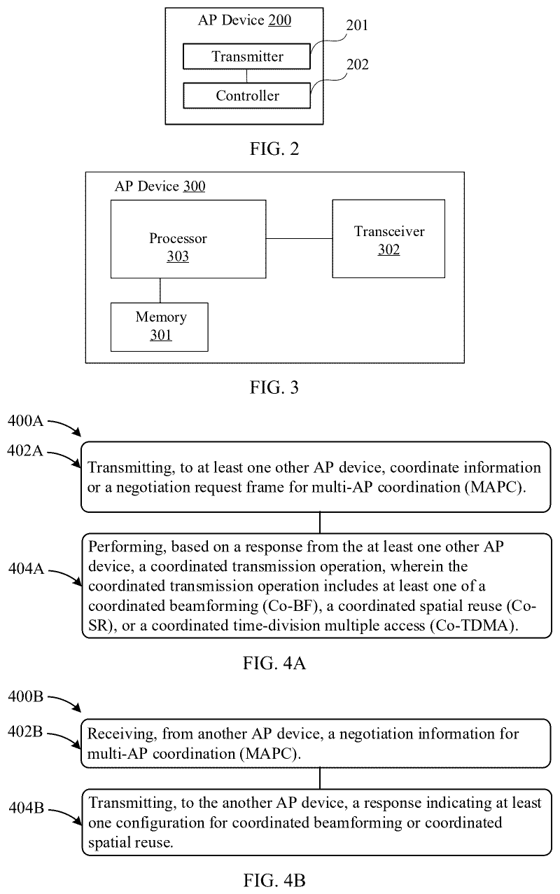

FIG. 2 illustrates an example of an AP device 200 according to an embodiment of the present application. The AP device 200 is configured to implement some embodiments of the disclosure. Some embodiments of the disclosure may be implemented into the AP device 200 using any suitably configured hardware and/or software. The AP device 200 includes a transmitter 201 and/or a controller 202. The transmitter is configured to transmit, to at least one other AP device, coordinate information or a negotiation request frame for multi-AP coordination (MAPC), and the controller 202 is configured to perform, based on a response from the at least one other AP device, a coordinated transmission operation, wherein the coordinated transmission operation includes at least one of a coordinated beamforming (Co-BF), a coordinated spatial reuse (Co-SR), or a coordinated time-division multiple access (Co-TDMA). This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

FIG. 3 illustrates an example of an AP device 300 according to an embodiment of the present disclosure. The AP device 300 is configured to implement some embodiments of the disclosure. Some embodiments of the disclosure may be implemented into the AP device 300 using any suitably configured hardware and/or software. The AP device 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to transmit, to at least one other AP device, coordinate information or a negotiation request frame for multi-AP coordination (MAPC), and the processor 303 is configured to perform, based on a response from the at least one other AP device, a coordinated transmission operation, wherein the coordinated transmission operation includes at least one of a coordinated beamforming (Co-BF), a coordinated spatial reuse (Co-SR), or a coordinated time-division multiple access (Co-TDMA). This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

In some embodiments, the coordinate information is carried by the negotiation request frame. In some embodiments, an initiating AP or a response AP is configured to update or teardown a MAPC agreement. In some embodiments, performing the coordinated transmission operation comprises: an initiating AP transmitting a medium access control (MAC) frame, and the MAC frame includes information with at least one of the followings: a transmission opportunity (TXOP) to be shared with the at least one other AP device, a channel bandwidth used for downlink transmission to one or more associated non-AP stations, or a number of spatial streams or transmit chains to be used for coordinated beamforming. In some embodiments, the initiating AP device and the responding AP device are specific operational roles of the AP device, and each AP device participating in the multi-AP coordination (MAPC) procedure may act as an initiating AP or a responding AP depending on the signaling flow.

In some embodiments, performing the coordinated transmission operation includes: an initiating AP transmitting a trigger frame to trigger a physical layer protocol data unit (PPDU) transmission using a channel bandwidth associated with the AP device. In some embodiments, performing the coordinated transmission operation includes: an initiating AP transmitting a null data packet announcement (NDPA) frame to trigger a unified sounding procedure for measuring channel state information (CSI) for both the AP device and the at least one other AP device. In some embodiments, during the unified sounding procedure, the AP device transmits a first null data packet (NDP) using a first number of transmit chains and receives a second NDP transmitted using a second number of transmit chains. In some embodiments, a response AP device adapts the channel bandwidth of an initiating AP, or adapts an unequal channel bandwidth of the initiating AP.

In some embodiments, the coordination information includes an indication of a transmission opportunity (TXOP) to be shared with the at least one other AP device. In some embodiments, the coordination information includes a channel bandwidth used for downlink transmission to one or more associated non-AP stations. In some embodiments, the coordination information includes a number of spatial streams or transmit chains to be used for coordinated beamforming. In some embodiments, the AP device selects one or more associated stations for coordinated beamforming prior to transmitting the coordination information. In some embodiments, performing the coordinated transmission operation includes transmitting a null data packet (NDP) or a physical layer protocol data unit (PPDU) using a channel bandwidth associated with the AP device. In some embodiments, the AP device adapts the channel bandwidth of an NDP transmission based on whether a station is associated with the AP device or with the at least one other AP device. In some embodiments, performing the coordinated transmission operation includes conducting a unified sounding procedure for measuring channel state information (CSI) for both the AP device and the at least one other AP device.

In some embodiments, during the unified sounding procedure, the AP device transmits a first NDP using a first number of transmit chains and receives a second NDP transmitted using a second number of transmit chains. In some embodiments, the coordinated transmission operation includes enabling at least one station associated with the AP device to perform opportunistic path-loss measurements of signals transmitted by the at least one other AP device. In some embodiments, the AP device transmits a trigger frame or a null data packet announcement (NDPA) frame containing an indication of transmit power to support the opportunistic path-loss measurements. In some embodiments, the coordination information includes initiating a multi-AP coordination (MAPC) negotiation including an indication of symmetrical or asymmetrical operation. In some embodiments, the coordination information includes an indication requesting the at least one other AP device to operate as a synchronization follower or synchronization reference. In some embodiments, the synchronization follower compensates a carrier frequency offset (CFO) based on the synchronization reference. In some embodiments, performing the coordinated transmission operation includes determining a reference AP device based on which AP device obtains a TXOP. In some embodiments, the method further includes transmitting, by the AP device, a termination indication to release roles or identifiers associated with a terminated MAPC agreement. In some embodiments, performing the coordinated transmission operation includes transmitting an initial control frame (ICF) to associated stations to determine availability for channel sounding or data transmission. In some embodiments, the AP device transmits an inviting frame to the at least one other AP device upon receiving at least one initial control reply (ICR) from the associated stations. In some embodiments, the AP device transmits a trigger frame to initiate physical layer protocol data unit (PPDU) transmission in response to receiving an acceptance indication from the at least one other AP device. In some embodiments, performing the coordinated transmission operation includes transmitting an initial control frame (ICF) to associated stations.

In some embodiments, the transceiver 302 is configured to receive, from another AP device, a negotiation information for multi-AP coordination (MAPC) and transmit, to the another AP device, a response indicating at least one configuration for coordinated beamforming or coordinated spatial reuse. This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

In some embodiments, the at least one configuration includes a channel bandwidth, number of spatial streams, or number of transmit chains. In some embodiments, the response indicates whether full or partial spatial nulling is to be performed. In some embodiments, the response indicates a request for the other AP device to operate as a shared AP device during a future transmission opportunity (TXOP). In some embodiments, the AP device initiates a sounding operation when obtaining a TXOP. In some embodiments, the AP device terminates participation in coordinated beamforming or coordinated spatial reuse by transmitting a termination indication.

The AP device includes a memory, processor, and transceiver that cooperate to execute multi-AP coordination functions, including transmitting coordination information to other APs, receiving negotiation information, and performing coordinated operations such as Co-BF, Co-SR, or Co-TDMA. The coordination information or response may specify TXOP sharing, channel bandwidth, the number of spatial streams or transmit chains, spatial-nulling behavior, or a request for another AP to act as a shared AP. The AP may select stations for Co-BF, adapt NDP/PPDU bandwidth per association, initiate unified sounding, support opportunistic path-loss measurement through NDP/NDPA or trigger frames with transmit-power indication, and participate in MAPC negotiation including asymmetric/symmetric roles or CFO-sync follower assignment. Coordinated operation further includes determining a reference AP based on TXOP, exchanging ICF/ICR frames with stations, sending inviting or trigger frames to partner APs, and transmitting a termination indication to release MAPC roles, thereby achieving robust, efficient, and flexible multi-AP coordination across diverse WLAN deployments.

FIG. 4A is an example of a method 400A of wireless communication performed by a AP device according to an embodiment of the present disclosure. The method 400A of wireless communication performed by the AP device is configured to implement some embodiments of the disclosure. Some embodiments of the disclosure may be implemented into the method 400A of wireless communication performed by the AP device using any suitably configured hardware and/or software. In some embodiments, the method 400A of wireless communication performed by the AP device includes: an operation 402A, transmitting, to at least one other AP device, coordinate information or a negotiation request frame for multi-AP coordination (MAPC); and an operation 404A, performing, based on a response from the at least one other AP device, a coordinated transmission operation, wherein the coordinated transmission operation includes at least one of a coordinated beamforming (Co-BF), a coordinated spatial reuse (Co-SR), or a coordinated time-division multiple access (Co-TDMA). This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

FIG. 4B is an example of a method 400B of wireless communication performed by a AP device according to an embodiment of the present disclosure. The method 400B of wireless communication performed by the AP device is configured to implement some embodiments of the disclosure. Some embodiments of the disclosure may be implemented into the method 400B of wireless communication performed by the AP device using any suitably configured hardware and/or software. In some embodiments, the method 400B of wireless communication performed by the AP device includes: an operation 402B, receiving, from another AP device, a negotiation information for multi-AP coordination (MAPC); and an operation 404B, transmitting, to the another AP device, a response indicating at least one configuration for coordinated beamforming or coordinated spatial reuse. This can solve issues in the prior art and other issues, enable unequal-bandwidth coordinated beamforming, enable unified low-overhead channel sounding, enable opportunistic path-loss measurement, enable robust multi-AP coordination, expand coordinated beamforming (Co-BF)/coordinated spatial reuse (Co-SR) applicability, improve efficiency, and/or enhance reliability across diverse WLAN deployments.

### Exemplary Technical Solutions:

Different WLAN devices may have different operating channel widths. Existing techniques do not address the potential problem of different channel bandwidths in Co-BF. These solutions implicitly assume that the transmissions in Co-BF use the same channel bandwidth, which is a major limitation to the usefulness of Co-BF. Existing Co-BF techniques assume equal channel bandwidths across APs, making them unable to support Co-BF when WLAN devices operate with different channel widths.

For a pair of AP devices in a Co-BF agreement, each may serve as a sharing AP device, which can lead to different spatial resource configurations for different sharing-shared AP device pairings. One drawback of this technique is that it accommodates only one of the two possible pairings of sharing-shared AP devices. Therefore, it requires two sounding operations for the two pairings. Existing Co-BF schemes support only one of the two possible sharing-shared AP pairings, forcing two separate sounding operations and reducing efficiency.

Existing techniques provide a scheme for coordinated measurement of path loss between AP devices and Wi-Fi stations for coordinated spatial reuse. There are two main drawbacks of the existing techniques are: 1) It requires defining new functionality for both AP devices and Wi-Fi stations, which leads to additional complexity in implementation. 2) It consumes airtime and hence adds overhead for data communications and reduces transmission efficiency. Existing Co-SR path-loss measurement schemes require new AP/STA functions and consume extra airtime, adding complexity and reducing transmission efficiency.

There are several drawbacks of existing techniques. Technical details for initiating MAPC (e.g., MLME primitives) have yet to be developed. CFO correction has been proposed. However, the proposed solution leads to a fairness issue regarding the roles of the AP devices. Termination of MAPC agreement has been proposed. However, technical details (e.g., MLME primitives and corresponding behaviors of AP devices and client devices) have yet to be developed. Existing MAPC techniques lack defined MLME procedures, create fairness issues in CFO correction, and lack clear termination behaviors.

Existing techniques provide channel sounding and data transmission in Co-BF. However, the existing techniques lack robustness. For instance, in the proposed sequences, if a response frame is not received by the intended AP device (e.g., due to the unavailability of a non-AP station), then the entire sequences fail. Existing Co-BF sounding and data-transmission procedures are fragile, as missing a single response frame can cause the entire sequence to fail.

Existing WLAN techniques for coordinated multi-AP operation suffer from several limitations. Current Co-BF designs assume equal channel bandwidths across AP devices, making them unsuitable for scenarios where APs operate with different bandwidth configurations. For sharing-shared AP pairings, existing methods support only one pairing at a time and require two separate sounding operations to cover both directions. Existing Co-SR path-loss-measurement approaches add implementation complexity by requiring new device functionalities and also increase airtime overhead, reducing transmission efficiency. Moreover, MAPC procedures remain incomplete, technical details such as MLME primitives, fairness in CFO-reference selection, and proper termination behaviors for APs and stations have not been fully defined. Proposed channel-sounding and data-transmission sequences in Co-BF are also fragile; if a required response frame is not received, the entire procedure may fail, indicating a lack of robustness in current solutions.

Some embodiments of the present disclosure provide an exemplary method for two access point devices in a wireless local area network to establish a mutual agreement and perform channel sounding operations for coordinated beamforming. Some embodiments of the present disclosure describe a method for Wi-Fi devices in a wireless local area network to measure path loss of wireless channels for coordinated spatial reuse. Some embodiments of the present disclosure provide an exemplary method for channel sounding and data transmission in coordinated beamforming and coordinated spatial reuse in a wireless local area network. Some embodiments of the present disclosure provide unified methods for two AP devices to establish coordinated-beamforming agreements and perform channel-sounding, for Wi-Fi devices to measure path loss for coordinated spatial reuse, and for robust channel sounding and data transmission in both Co-BF and Co-SR within WLANs.

### Exemplary Technical Solution 1:

Wi-Fi access points for home, small office, and enterprise (e.g., wireless router, broadband gateway, mesh Wi-Fi system). Coordinated beamforming (Co-BF) in a wireless local area network is a technology that enables access point (AP) devices from different basic service sets (BSSs) to deploy multiple transmit antennas in a coordinated fashion to mitigate interference across the BSSs.

An initiating AP device for coordinated beamforming is an AP device which initiates coordinated beamforming with other AP devices and offers to share its future transmission opportunities (TXOPs) with them. A responding AP device for coordinated beamforming is an AP device which is selected by the initiating AP device to participate in coordinated beamforming. Usually, as the holder of a single TXOP, an initiating AP device shares it with a single responding AP device.

The initiating AP device selects one or more stations from all its associated non-AP stations to participate in coordinated beamforming. The initiating AP device then determines a channel bandwidth for the downlink data transmissions to the selected stations. The channel bandwidth may be the same as the operating channel width of one of the selected non-AP stations. The initiating AP device transmits a control frame packet (e.g. an initial control frame or a trigger frame) to multiple candidate AP devices to solicitate participation in coordinated beamforming. The control frame packet contains the channel bandwidth for the downlink data transmissions from the initiating AP device to its selected non-AP stations. The candidate AP devices are from the overlapping basic service sets of the initiating AP device.

Upon receiving the control frame packet from the initiating AP device, if a candidate AP device intends to participate in coordinated beamforming with the initiating AP device, it selects one or more stations from all its associated non-AP stations and determines a channel bandwidth for the downlink data transmissions to the selected stations. It then transmits a responding frame packet to the initiating AP device to indicate its intention with the identification of its selected non-AP stations for coordinated beamforming as well as the channel bandwidth to be used for downlink transmissions to its selected non-AP stations.

Upon receiving the responding frame packets from all the interested candidate AP devices, the initiating AP device selects one of them for coordinated beamforming and starts sounding operations and data transmissions. The chosen AP device becomes a responding AP device for coordinated beamforming.

There are three scenarios in sounding operations and data transmissions for the channel bandwidths used by the two AP devices in coordinated beamforming: (1) the two AP devices use the identical channel bandwidth; (2) the responding AP device uses a larger channel bandwidth than the initiating AP device does; and (3) the responding AP device uses a smaller channel bandwidth than the initiating AP device does.
1) If the two AP devices use the same channel bandwidth, then both AP devices transmit null data packets (NDPs) and physical layer protocol data units (PPDUs) using the same PPDU bandwidth (i.e., identical to the channel bandwidth) for coordinated beamforming.
2) If the responding AP device uses a larger channel bandwidth than the initiating AP device does, a. the initiating AP device transmits NDPs and PPDUs with its own channel bandwidth, b. the responding AP device transmits NDPs with its own channel bandwidth if its associated non-AP stations are the recipients, c. ..the responding AP device transmits NDPs with the channel bandwidth of the initiating AP device if the non-AP stations associated with the initiating AP device are the recipients, and d. the responding AP device transmits PPDUs with its own channel bandwidth.
3) If the responding AP device uses a smaller channel bandwidth than the initiating AP device does, a. the initiating AP device transmits PPDUs with its own channel bandwidth, b. the initiating AP device transmits NDPs with its own channel bandwidth if its associated non-AP stations are the recipients, c. the initiating AP device transmits NDPs with the channel bandwidth of the responding AP device if the non-AP stations associated with the responding AP device are the recipients, d. the responding AP device transmits NDPS and PPDUs with its own channel bandwidth.

Once the agreement for Co-BF between two AP devices is established and their respective channel bandwidths for Co-BF transmissions are determined, the channel bandwidths remains constant until the agreement is teared down.

Some embodiments of the present disclosure propose a solution for enabling WLAN AP devices to deploy unequal channel bandwidths in coordinated beamforming. The solution is the first to address the topic and it significantly expands the scope of coordinated beamforming, allowing more WLAN devices to enjoy the performance gain resulting from coordinated beamforming.

Some embodiments of the disclosure present a coordinated-beamforming (Co-BF) procedure enabling WLAN AP devices to negotiate participation, exchange channel-bandwidth information, select participating stations, and perform sounding/data transmission even when the initiating AP and responding AP use unequal channel bandwidths. An initiating AP selects stations, determines its DL channel bandwidth, and broadcasts a control frame to candidate APs; candidate APs reply with their selected stations and bandwidths; the initiating AP selects one responding AP and begins Co-BF. Three bandwidth-relationship scenarios (equal, responding-AP larger, responding-AP smaller) are supported through adaptive NDP/PPDU bandwidth selection for each AP and for each station group. Once established, the agreed bandwidths remain fixed for the duration of the Co-BF agreement. This solution is the first to support unequal-bandwidth Co-BF and significantly broadens applicability and performance benefits of coordinated beamforming in WLANs.

### Exemplary Technical Solution 2:

Wi-Fi access points for home, small office, and enterprise (e.g., wireless router, broadband gateway, mesh Wi-Fi system). Coordinated beamforming (Co-BF) in a wireless local area network (WLAN) is a technology where multiple access point (AP) devices from different basic service sets (BSSs) deploy multiple transmit antennas to transmit data in a coordinated fashion in order to mitigate interference across the BSSs. A sharing AP device in Co-BF is an AP device that shares its obtained transmission opportunity (TXOP) with other AP devices for data transmission with Co-BF. A shared AP device in Co-BF is an AP device that transmits data during the TXOP held by the sharing AP device. Before starting data transmissions with Co-BF, a sharing AP device and a shared AP device establish an agreement for transmission configurations and perform sounding operations to measure the channel state information (CSI). Co-BF allows multiple WLAN AP devices to share a TXOP, negotiate transmission configurations, and perform CSI-based sounding so they can jointly transmit with reduced inter-BSS interference.

Assume that two AP devices, AP1 and AP2, perform coordinated beamforming in the downlink direction. If both AP1 and AP2 have sufficient spatial resources (e.g., sufficient transmit chains), both can deploy beamforming to fully eliminate the mutual interferences at their respective receivers (i.e., achieving full spatial nulling). With coordinated beamforming in the downlink direction, if AP1 and AP2 transmit x and y spatial streams, respectively, then the minimum numbers of transmit chains deployed by AP1 and AP2, respectively, to achieve full spatial nulling to eliminate overlapped BSS (OBSS) interference are both x+y. If one of the AP devices or both do not deploy sufficient transmit chains (i.e., less than x+y chains), then only partial spatial nulling can be achieved so that the OBSS interference cannot be fully eliminated, and the performance may still be acceptable if the residual interference at the receivers can be tolerated. Full or partial spatial nulling in Co-BF depends on whether both APs have at least x+y transmit chains; with fewer chains, only partial nulling is achievable and some residual OBSS interference remains.

Without loss of generality, let's assume that among all the AP devices interested in being a sharing AP for Co-BF, AP1 is the first to obtain a TXOP for initiating negotiation with other APs for Co-BF.
1) AP1 selects one or more stations from all its associated non-AP stations. This selection may be based on the buffer status of downlink traffic and/or the active service periods for these stations. AP1 selects one or more of its associated stations based on traffic needs or active service periods.
2) AP1 determines a set of configurations for the downlink data transmissions to the selected stations. The set may include the channel bandwidth used for Co-BF transmissions, the number of spatial streams for each station to receive, and the number of transmit chains. AP1 determines the downlink transmission configuration (bandwidth, spatial streams, transmit-chain count) for the selected stations.
3) AP1 transmits a management frame packet to multiple candidate AP devices to solicitate participation in coordinated beamforming. The management frame packet contains the set of configurations for the downlink data transmissions from AP1 to its selected non-AP stations. In addition, the management frame packet may indicate whether full spatial nulling is required for a candidate shared AP device (i.e., no degradation in performance) or how much performance degradation (e.g., reduction in signal to interference and noise ratio (SINR) at the corresponding receivers) can be tolerated by AP1. The candidate AP devices are from the OBSS of AP1 and have indicated their capability of Co-BF. AP1 sends a management frame to candidate APs in its OBSS to invite Co-BF participation, conveying its transmission configurations and required nulling/performance constraints.
4) Upon receiving the management frame packet from AP1, if a candidate AP device intends to participate in Co-BF as a shared AP device with AP1 being the sharing AP, it selects one or more stations from all its associated non-AP stations and transmits a responding management frame packet to AP1 to indicate its intention and a set of configurations for the downlink data transmissions to the selected stations. The set may include the channel bandwidth used for Co-BF transmissions, the number of spatial streams for each station to receive, and the number of transmit chains. A candidate AP that wishes to join Co-BF replies with its own selected stations and transmission configurations, and may also request reciprocal sharing-AP participation with AP1. If the candidate AP device also intends to become a sharing AP for Co-BF with the same stations, it may choose to do one of the following.
   a. It may initiate a Co-BF negotiation procedure as a sharing AP device with AP1 (i.e., the one similar to the above steps 1-3) when it obtains a TXOP.
   b. It may include in the responding management frame packet a request for AP1 to serve as a shared AP device when it becomes a sharing AP for Co-BF.
5) Upon receiving the responding frame packets from all the interested candidate AP devices, AP1 selects one of them as its Co-BF partner (i.e., a shared AP device). If the selected shared AP device (say AP2) requests that AP1 serves as a shared AP when AP2 obtains a TXOP and becomes a sharing AP device for Co-BF, AP1 may choose to respond with a management frame packet to AP2 to accept the request with a set of configurations as a shared AP device for the downlink data transmissions to its selected stations (e.g., the channel bandwidth, the number of spatial streams for each station to receive, and the number of transmit chains) or reject the request. AP1 selects one candidate AP as its Co-BF partner and may accept or reject that AP's request for AP1 to also act as a shared AP when the partner becomes the future TXOP holder.
6) After the negotiation for Co-BF is complete, each of the AP may perform a sounding operation if it obtains a TXOP.

For example, two AP devices, AP1 and AP2, are coordinated beamforming partners and both intend to be a sharing AP for Co-BF after obtaining a TXOP. Each device has six transmit chains. When AP1 becomes a TXOP holder, it uses all six transmit chains to transmit four spatial streams to its associated non-AP stations, and AP2 uses all six transmit chains to transmit two spatial streams to its associated non-AP stations so that full spatial nulling is achieved for the transmissions from both AP devices. On the other hand, when AP2 becomes a TXOP holder, it also uses all six transmit chains to transmit four spatial streams to its associated non-AP stations, and AP1 uses all six transmit chains to transmit two spatial streams to its associated non-AP stations so that full spatial nulling is achieved for the transmissions from both AP devices. While the spatial configurations for the transmissions from the two AP devices are different due to different TXOP holders, the following unified sounding operation is adequate to obtain the CSI required for implementing full spatial nulling in both cases of TXOP holder. Even though AP1 and AP2 use different spatial-stream configurations depending on which one holds the TXOP, a single unified sounding operation provides all CSI needed to achieve full spatial nulling in both cases.

When CSI from the AP devices to the non-AP stations associated with AP1 is to be measured, AP1 and AP2 transmit NDPs with six and two transmit chains, respectively.

When CSI from the AP devices to the non-AP stations associated with AP2 is to be measured, AP1 and AP2 transmit NDPs with two and six transmit chains, respectively.

Some embodiment of the present disclosure provide a multi-AP Co-BF negotiation procedure, which allows each AP device to serve as a sharing AP in Co-BF. The existing technique(s) use(s) two negotiation procedures to achieve the same agreement; hence, it is less efficient than the present technique. Some embodiment of the present disclosure provide a channel sounding scheme for Co-BF. The proposed scheme measures the CSI for two scenarios of sharing-shared AP device pairing with a single unified sounding operation. The prior art requires two sounding operations to achieve the same result and hence results in more overhead. Some embodiments enable a more efficient multi-AP Co-BF negotiation and a unified sounding procedure that obtains CSI for both AP-pairing scenarios with a single operation instead of two.

Some embodiment of the present disclosure describe a comprehensive multi-AP coordinated-beamforming (Co-BF) procedure in which AP devices negotiate shared-TXOP partnerships, exchange downlink transmission configurations (bandwidth, spatial streams, transmit-chain counts, and required nulling levels), and flexibly decide whether each AP will act as a sharing AP, a shared AP, or both depending on future TXOP ownership. After negotiation, either AP may initiate unified sounding when it obtains a TXOP, enabling CSI acquisition for both AP1-as-sharing-AP and AP2-as-sharing-AP scenarios using only a single unified sounding operation rather than two separate ones. This unified design supports full or partial spatial nulling depending on available transmit chains, allows both APs to act as sharing APs, reduces overhead compared with prior art, and provides an efficient and scalable Co-BF negotiation and sounding mechanism for WLAN deployments.

### Exemplary Technical Solution 3:

Wi-Fi access points for home, small office, and enterprise (e.g., wireless router, broadband gateway, mesh Wi-Fi system), Wi-Fi client devices (e.g., computers, tablets, mobile phones, smart wearables) Coordinated spatial reuse (Co-SR) in a wireless local area network (WLAN) is a technology to allow more efficient wireless medium usage by concurrent transmissions from multiple access point (AP) devices through transmit power control to suppress the interference between the transmissions. Co-SR allows multiple AP devices to transmit concurrently by adjusting transmit power to reduce mutual interference and improve medium efficiency.

To effectively control transmit power, the devices estimate the path loss between each pair of transmitter (e.g., an AP device) and receiver (e.g., a non-AP station) out of the set of Wi-Fi devices involved in Co-SR. An AP device transmits beacon frames periodically, which indicate their transmit power. A station may measure the received signal strength indicator or signal-to noise ratio of the channel from the AP device using a received beacon frame and then estimate the path loss of the channel with the transmit power information indicated in the beacon frame. It typically takes more than 100 milliseconds to complete the measurement process. When the station is moving, the path loss changes, which requires more frequent measurements to estimate the path loss. Path-loss estimation in Co-SR relies on beacon-based measurements, which are slow, infrequent, and inadequate for tracking rapid changes, especially when stations are moving.

An AP device provides its associated non-AP stations with the identifications of the AP devices with which it has established Co-SR agreements. These AP devices are called target AP devices. Besides performing measurements of path loss using the periodical beacon frames, these stations can perform measurement of path loss from the target AP devices when any of the following opportunities occur. Stations may measure path loss from target AP devices not only via periodic beacons but also whenever additional transmission opportunities occur.
1) A target AP device transmits a trigger frame for various purposes. In the Common Info field of a trigger frame (provided that it contains at least one Common Info field), the AP device (i.e., the sender of the trigger frame) indicates the transmit power it uses when transmitting the trigger frame. For instance, the field indicates the AP device's combined transmit power at the transmit antenna connector of all the antennas used to transmit the triggering physical layer protocol data unit (PPDU) in units of dBm/20 MHz. Though the trigger frame may not be addressed to an unassociated non-AP station, the station can still measure the path loss from the target AP device when receiving this trigger frame. The following are examples of trigger frames with indication of transmit power: a. a basic trigger frame soliciting trigger-based (TB) PPDU transmissions in the uplink direction, b. a Beamforming Report Poll trigger frame, c. a Ranging/Sensing trigger frame. Stations can opportunistically measure path loss when a target AP transmits any trigger frame that includes a transmit-power indication.
2) For channel sounding within a basic service set (BSS), ranging, and sensing operations, a target AP device transmits a null data packet announcement (NDPA) frame followed by a null data packet (NDP). The NDPA frame contains a special STA Info field, which contains a subfield indicating the transmit power used to transmit the following NDP. Though the NDPA frame may not be addressed to an unassociated non-AP station, the station can still measure the path loss from a target AP device when receiving the NDPA frame and the following NDP sent by the target AP device. Stations can also measure path loss when a target AP transmits an NDPA/NDP pair that includes a transmit-power indication.
3) For coordinated beamforming (Co-BF), cross-BSS channel sounding is a necessary procedure. Suppose that AP1 is an AP device who obtains the current TXOP to initiate a cross-BSS sounding procedure and AP2 is an AP device participating in both Co-BF and Co-SR with AP1. Therefore, AP2 is a target AP device for the stations associated with AP1 and participating in Co SR. To initiate cross-BSS sounding, AP1 transmits a Co-BF NDPA frame addressing to AP2 and the non-AP stations associated with AP1, including those participating in Co-BF or Co-SR. After a short interframe space (SIFS), AP2 transmits an NDP. AP1 may indicate in the NDPA frame the transmit power used by AP2 to transmit the NDP. The stations associated with AP1 participating in Co-SR instead of Co-BF measure the path loss from AP2 with the received NDP as well as AP2's transmit power indicated in the NDPA frame sent by AP1. Stations may opportunistically measure path loss from a target AP during cross-BSS Co-BF sounding when AP1 sends a Co-BF NDPA and AP2 responds with an NDP carrying (or indicated with) its transmit-power information.
4) For multi-AP coordination (MAPC), an AP device may be willing to share its transmission opportunity (TXOP) with other AP devices. Such an AP device is called a sharing AP device. When a sharing AP device obtains a TXOP, it may transmit control frames to other AP devices which are under an MAPC agreement with the sharing AP device. The sharing AP device may indicate transmit power in the control frames to facilitate the unassociated stations participating in Co-SR to measure the path loss from the sharing AP device. The following are examples of the control frames. a. The sharing AP device may transmit a trigger frame to poll other AP devices to determine their intention to participate in MAPC (e.g., Co TDMA, Co-SR, Co-BF sounding and data transmission) during the current TXOP. b. The sharing AP device may transmit a control frame to an AP device to determine its availability to participate in MAPC (e.g., Co-SR, Co-BF sounding and data transmission) during the current TXOP. Stations can also measure path loss during MAPC when a sharing AP, upon obtaining a TXOP, transmits control or trigger frames with transmit-power indication to other APs under the MAPC agreement.

Some embodiments of the present disclosure propose a solution for enabling Wi-Fi stations to conduct opportunistic measurements of path loss from the AP devices in overlapped BSSs. The present techniques allow for more frequent and more accurate measurements of path loss than the periodical Beacon-based measurements in the current WLAN standard. It is also more efficient than the dedicated measurement scheme proposed in existing techniques, as the present techniques are based on existing and emerging Wi-Fi functionalities and does not require additional airtime for measurement. Some embodiments enable efficient, frequent, and accurate opportunistic path-loss measurements using existing Wi-Fi frame transmissions without adding airtime overhead.

Some embodiments of the present disclosure present an opportunistic path-loss measurement solution for coordinated spatial reuse (Co-SR), enabling Wi-Fi stations to measure path loss more frequently and accurately by leveraging existing transmission opportunities—such as trigger frames with transmit-power indication, NDPA/NDP exchanges for sounding, cross-BSS sounding during Co-BF, and MAPC control frames from sharing AP devices—rather than relying solely on periodic beacons or requiring new measurement procedures. By allowing stations to measure received power from target AP devices whenever these ordinary Wi-Fi frames are transmitted, the proposed approach avoids added airtime overhead, reduces complexity, supports mobile stations with rapidly changing path loss, and provides a more efficient and practical Co-SR mechanism than existing techniques.

### Exemplary Technical Solution 4:

Wi-Fi access points for home, small office, and enterprise (e.g., wireless router, broadband gateway, mesh Wi-Fi system). Multiple access point coordination (MAPC) in a wireless local area network (WLAN) refers to a set of schemes among multiple access point (AP) devices from overlapped basic service sets (OBSSs) to coordinate their transmissions for improved wireless media usage. MAPC enables multiple overlapping AP devices to coordinate transmissions for more efficient WLAN medium usage.

Typical schemes of MAPC include coordinated beamforming (Co-BF), coordinated spatial reuse (Co-SR), and coordinated time division multiple access (Co-TDMA). Co-BF is a technology that enables AP devices from OBSSs to deploy multiple transmit antennas in a coordinated fashion to mitigate interference across the BSSs. For a given transmission opportunity (TXOP), the AP device that is the TXOP holder only shares the TXOP for Co-BF transmission with one AP device. Co-SR is a technology to allow more efficient wireless medium usage by concurrent transmissions from multiple AP devices through transmit power control to suppress the interference between the transmissions. MAPC covers Co-BF, Co-SR, and Co-TDMA, allowing overlapping APs to coordinate antennas or transmit power to reduce interference and improve medium efficiency.

Co-TDMA is a procedure that enables an AP device that has obtained a TXOP to share a time portion of the obtained TXOP with a set of AP devices. In MAPC, a sharing AP device refers to an AP device that shares its obtained TXOP with other AP devices for data transmission, and a shared AP device refers to an AP device that transmits data during the TXOP held by the sharing AP device. Two AP devices may establish an MAPC agreement for more than one MAPC scheme. For each MAPC scheme, there are two types of roles for the responding AP device. Co-TDMA allows TXOP time-sharing, with MAPC supporting symmetrical (share or be shared) and asymmetrical (shared-only) AP roles.
1) Symmetrical mode: the responding AP device serves as either a sharing AP device or a shared AP device.
2) Asymmetrical mode: The responding AP device only serves as a shared AP device.

An initiating AP device for MAPC is an AP device that initiates MAPC agreement negotiation and indicates the intention of sharing its TXOPs. To initiate a MAPC negotiation, the station management entity (SME) of the initiating AP device can issue a media access control (MAC) layer management entity (MLME) primitive that results in the transmission of management frames from the initiating AP device to one or more responding AP devices. In the management frames, the initiating AP device may indicate whether the asymmetrical mode for each MAPC scheme is acceptable. An initiating AP starts MAPC negotiation by sending management frames (via SME/MLME) that announce its TXOP-sharing intent and indicate whether asymmetrical mode is acceptable.

Upon reception of the management frame for initiating MAPC negotiation from the initiating AP device, a responding AP device can validate the frame and issue an MLME primitive to indicate the reception. The SME of the responding AP device can issue an MLME primitive to cause the transmission of a management frame to the initiating AP device to respond to its request for MAPC negotiation. If and only if the initiating AP device indicates that the asymmetrical mode for a certain MAPC scheme is acceptable, the responding AP device may choose between symmetrical mode and asymmetrical mode for the scheme and indicate its choice in the responding management frame. A responding AP validates the negotiation frame, replies via MLME with its chosen mode, and may select symmetrical or asymmetrical operation only if the initiating AP has allowed asymmetrical mode.

Upon reception of the management frame from the responding AP device, the initiating AP device can validate the frame and issue an MLME primitive to confirm. If the initiating AP device does not receive any management frame from the responding AP device within a timeout period, the MAPC negotiation can be considered unsuccessful. In the context of Co-BF, carrier frequency offset (CFO) between the two AP devices refers to a mismatch between the frequences of the signals transmitted by the two AP devices due to different local oscillators. One of the two AP devices should serve as a reference AP and the other as a synchronization follower AP. The synchronization follower AP device can estimate and compensate for CFO with respect to the reference AP device during the channel sounding phases and data transmission phases. The role of reference AP and synchronization follower AP may be decided deterministically or stochastically and remains unchanged under the current Co-BF agreement. Once the initiating AP receives the response, it confirms the negotiation; if no response arrives before the timeout, the negotiation fails, and for Co-BF, the two APs determine one as the reference AP and the other as the synchronization-follower AP to perform CFO estimation and compensation.

The role of reference AP and synchronization follower AP may be decided deterministically during the Co-BF negotiation stage. An initiating AP device may initiate a negotiation with one or more AP devices and may transmit individually addressed management frames to establish a MAPC agreement with one or more AP devices. In the management frame, the initiating AP device may request that a responding AP device should serve as a synchronization follower AP for completing the Co-BF agreement. The initiating AP can deterministically assign roles during Co-BF negotiation, requesting responding APs to act as synchronization-follower APs when establishing MAPC agreements.

The role of reference AP and synchronization follower AP may be decided stochastically after the Co-BF negotiation stage. An initiating AP device may initiate a negotiation with one or more AP devices and may transmit individually addressed management frames to establish a MAPC agreement with one or more AP devices. In the management frame, the initiating AP device does not request that a responding AP device should serve as a synchronization follower AP. Instead, between the two AP devices under an established Co-BF agreement, the one that obtains a TXOP first to conduct channel sounding operation can serve as a reference AP. In stochastic mode, whichever AP first obtains a TXOP for channel sounding becomes the reference AP, with no follower role pre-assigned during negotiation.

For an asymmetrical mode Co-BF agreement, it is fairer that the sharing AP device should serve as the reference AP. For a pair of AP devices in an MAPC agreement, either of them can initiate the termination of the agreement at any time. If there are multiple MAPC schemes under the agreement, the termination of one or more schemes can be initiated simultaneously. If all MAPC schemes in an MAPC agreement are terminated, each AP device can release the identification assigned to its peer AP device in the MAPC agreement. An MLME primitive can be issued by an AP device to initiate the termination of the MAPC agreement and transmit a management frame to the MAPC partner AP device requesting termination of the MAPC agreement. The AP device that initiates the termination of MAPC schemes can issue a primitive to confirm the termination upon completion of the transmission of the management frame and terminate the operations related to the terminating MAPC schemes. The AP device that receives the management frame addressed to it can issue an MLME primitive to indicate the requested termination and can terminate the operations related to the terminating MAPC schemes. In an asymmetrical Co-BF agreement, the sharing AP generally serves as the reference AP, and either AP may terminate any or all MAPC schemes at any time through MLME-triggered management-frame signaling.

After a Co-SR agreement is terminated, each AP device that is under the agreement can transmit a management frame to its associated stations which have been participating in Co-SR and request that they do not measure the path loss or received signal strength indicator from the OBSS AP devices involved in the Co-SR agreement. For instance, the management frame can contain the identifications of those OBSS AP devices. After a Co-SR agreement ends, each AP sends management frames instructing its associated stations to stop measuring path-loss or RSSI from the OBSS APs previously involved.

Some embodiments of the present disclosure propose solutions for negotiation and termination of multi AP coordination. It has the following innovative components. 1) Some embodiments propose a novel procedure for initiating MAPC negotiation, which allows for negotiation of symmetrical and asymmetrical modes. 2) Some embodiments propose two novel solutions to deal with the fairness issue caused by CFO correction in Co-BF. 3) Some embodiments propose a novel procedure for terminating MAPC agreements, which includes the behavior of AP devices under the terminated Co-SR agreement. Some embodiments introduce innovative MAPC negotiation and termination mechanisms, including flexible mode negotiation, fair Co-BF CFO-handling methods, and a unified procedure for ending MAPC agreements and related Co-SR behavior.

Some embodiments of the disclosure present a comprehensive MAPC (multi-AP coordination) framework that introduces a unified and robust method for negotiating and terminating coordinated operations, including Co-BF, Co-SR, and Co-TDMA, by defining clear SME/MLME signaling flows, supporting both symmetrical and asymmetrical modes, providing two fairness-preserving mechanisms for CFO reference-AP selection, and specifying detailed termination behavior (including Co-SR post-termination station instructions), thereby solving unaddressed gaps in existing techniques and enabling practical, efficient, and fair multi-AP coordination in WLANs.

### Exemplary Technical Solution 5:

Wi-Fi access points for home, small office, and enterprise (e.g., wireless router, broadband gateway, mesh Wi-Fi system). Multiple access point coordination (MAPC) in a wireless local area network (WLAN) refers to a set of schemes among multiple access point (AP) devices from overlapped basic service sets (OBSSs) to coordinate their transmissions for improved wireless media usage. MAPC enables multiple OBSS APs to coordinate transmissions to improve overall wireless medium efficiency. Co-BF and Co-SR improve WLAN efficiency by coordinating multi-AP transmissions to reduce interference and enable concurrent use of the wireless medium.

Coordinated beamforming (Co-BF) and coordinated spatial reuse (Co-SR) are two examples of MAPC.

Co-BF is a technology that enables AP devices from OBSSs to deploy multiple transmit antennas in a coordinated fashion to mitigate interference across the basic service sets (BSSs). For a given transmission opportunity (TXOP), the AP device that is the TXOP holder only shares the TXOP for Co BF transmission with one AP device.

Co-SR is a technology to allow more efficient wireless medium usage by concurrent transmissions from multiple AP devices through transmit power control to suppress the interference between the transmissions.

In both Co-BF and Co-SR, a sharing AP device refers to an AP device that shares its obtained TXOP with other AP devices for data transmission, and a shared AP device refers to an AP device that transmits data during the TXOP held by the sharing AP device. In Co-BF and Co-SR, a sharing AP lets other APs use its TXOP, while shared APs transmit within that shared TXOP.

For Co-BF transmission, a channel sounding phase is required for both AP devices to obtain channel state information in order to derive precoding matrices for data transmission. The following procedure is designed for channel measurement conducted by the non-AP stations associated with the sharing AP device. For Co-BF, both APs require a channel-sounding phase to obtain CSI, and the following procedure supports channel measurements by stations associated with the sharing AP.
1) Upon obtaining a TXOP, the sharing AP device transmits a control frame (e.g., an initial control frame (ICF)) to the set of its associated stations to which it intends to perform channel sounding. The main purpose of the control frame is to check the availability of the stations associated with the sharing AP. When the sharing AP obtains a TXOP, it first sends an initial control frame to check whether its associated stations are available for sounding.
2) A short interframe space (SIFS) after receiving the control frame from the sharing AP device, an associated station may transmit a control frame (e.g., initial control reply (ICR)) to the sharing AP device indicating its availability. After receiving the control frame, each associated station replies after a SIFS with a control response indicating its availability.
3) If the sharing AP does not receive any response from its associated stations, it does not proceed with channel sounding; otherwise, an SIFS after receiving the response frames from the stations the sharing AP device transmits an inviting frame to the shared AP device to invite the latter to participate in channel sounding during this TXOP. If at least one station responds, the sharing AP sends an inviting frame after a SIFS to request the shared AP to join the channel-sounding procedure.
4) An SIFS after receiving the inviting frame from the sharing AP device, the shared AP device transmits a response frame to the sharing AP device indicating that it accepts the invitation to participate in channel sounding during this TXOP. After receiving the invitation, the shared AP replies after a SIFS to confirm its participation in channel sounding for the TXOP.
5) An SIFS after receiving the response frame from the shared AP device, the sharing AP device transmits a null data packet announcement (NDPA) frame to start a typical channel measurement procedure. After receiving the shared AP's response, the sharing AP sends an NDPA after a SIFS to begin the channel-measurement procedure.

A similar procedure can be used for channel measurement conducted by the non AP stations associated with the shared AP device. For instance, the ICF/ICR frame exchange is between the shared AP device and its associated stations.

The following procedure is designed for data transmission in either Co-BF or Co-SR.
1) Upon obtaining a TXOP, the sharing AP device transmits a control frame (e.g., an initial control frame (ICF)) to the set of its associated stations to which it has downlink traffic to transmit. The main purpose of the control frame is to check the availability of the stations.
2) A short interframe space (SIFS) after receiving the control frame from the sharing AP device, an associated station may transmit a control frame (e.g., initial control reply (ICR)) to the sharing AP device indicating its availability.
3) If the sharing AP does not receive any response from its associated stations, it does not proceed with Co-BF/Co-SR; otherwise, an SIFS after receiving the response frames from the stations the sharing AP device transmits an inviting frame to the shared AP device to invite the latter to participate in Co-BF/Co-SR during this TXOP.
4) An SIFS after receiving the inviting frame from the sharing AP device, the shared AP device transmits a control frame (e.g., an initial control frame (ICF)) to the set of its associated stations to which it has downlink traffic to transmit. The main purpose of the control frame is to check the availability of the stations.
5) An SIFS after receiving the control frame from the shared AP device, an associated station may transmit a control frame (e.g., initial control reply (ICR)) to the shared AP device indicating its availability.
6) Case 1: If the shared AP does not receive any response from its associated stations, it transmits a response frame to the sharing AP device to decline the invitation for joining Co-BF/Co-SR.
   Case 2: An SIFS after receiving response frames from its associated stations, the shared AP device transmits a response frame to the sharing AP device indicating that it accepts the invitation to participate in Co-BF/Co-SR during this TXOP.
7) An SIFS after receiving the response frame from the shared AP device, the sharing AP device transmits a trigger frame to trigger the transmission of physical layer protocol data unit (PPDU) in the downlink direction.

Some embodiments describe a coordinated Co-BF/Co-SR data-transmission procedure where both the sharing AP and shared AP first verify their associated stations'availability through ICF/ICR exchanges; the shared AP may accept or decline participation based on station responses, and if accepted, the sharing AP finally issues a trigger frame to start DL PPDU transmission.

Some embodiments of the present disclosure provide an exemplary solution for channel sounding and data transmission in Co-BF and data transmission in Co-SR. It has the following innovative components. 1) The proposed procedures are novel. 2) The proposed procedures are more robust the prior art in that they take into account the various possible behaviors of Wi-Fi stations/clients. Some embodiments introduce novel and more robust Co-BF/Co-SR sounding and transmission procedures that account for diverse station behaviors.

Some embodiments of the disclosure introduces a unified and robust framework for channel-sounding and data-transmission procedures in Co-BF and Co-SR, using a structured ICF/ICR-based availability check, AP-to-AP invitation/response exchanges, and conditional transmission triggering, enabling reliable operation under diverse client behaviors and providing a novel, more resilient alternative to the fragile procedures in existing techniques.

In summary, some embodiments of the disclosure provide a comprehensive, unified multi-AP coordination framework that advances WLAN Co-BF, Co-SR, and Co-TDMA by enabling unequal-bandwidth coordinated beamforming, efficient shared-TXOP negotiation with unified low-overhead sounding, opportunistic path-loss measurement without added airtime, fair and fully specified MAPC negotiation/termination procedures, and robust ICF/ICR-based channel-sounding and data-transmission flows, collectively delivering broader applicability, higher efficiency, greater robustness, and practical deployability across diverse WLAN environments.

Commercial interests for some embodiments are as follows. 1. Solve issues in the prior art and other issues. 2. Enable unequal-bandwidth coordinated beamforming. 3. Enable unified low-overhead channel sounding. 4. Enable opportunistic path-loss measurement. 5. Enable robust multi-AP coordination. 6. Expand coordinated beamforming (Co-BF)/coordinated spatial reuse (Co-SR) applicability. 7. Improve efficiency, and/or enhance reliability across diverse WLAN deployments. 8. Provide a good communication performance. 9. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

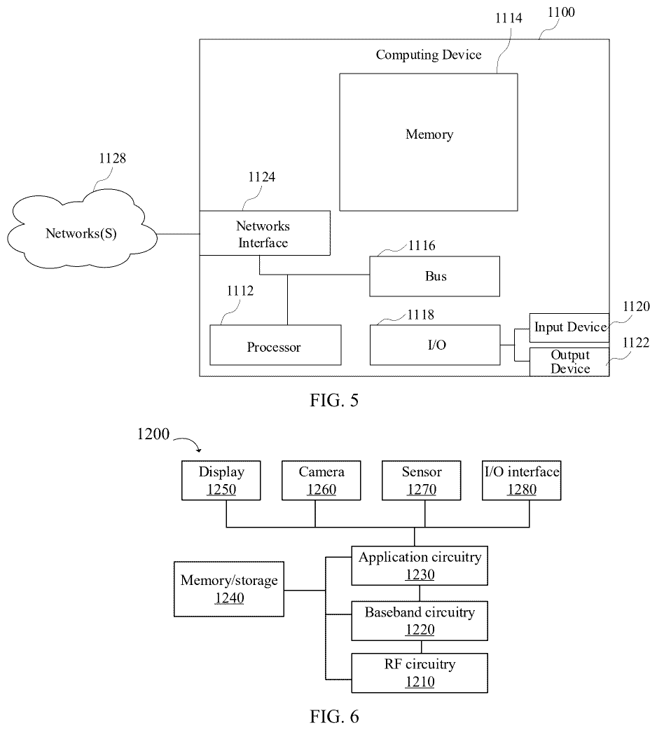

FIG. 5 is an example of a computing device 1100 according to an embodiment of the present disclosure. Any suitable computing device can be used for performing the operations described herein. For example, FIG. 5 illustrates an example of the computing device 1100 that can implement some embodiments of FIG. 1A to FIG. 4 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1A to FIG. 4. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 6 is a block diagram of an example of a communication system 1200 according to an embodiment of the present disclosure. Embodiments described herein may be implemented into the communication system 1200 using any suitably configured hardware and/or software. FIG. 6 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1A to FIG. 4. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1A to FIG. 4 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of coordinated operation performed by an access point (AP) device in a wireless local area network (WLAN), comprising:
transmitting, to at least one other AP device, coordinate information or a negotiation request frame for multi-AP coordination (MAPC); and
performing, based on a response from the at least one other AP device, a coordinated transmission operation, wherein the coordinated transmission operation comprises at least one of a coordinated beamforming (Co-BF), a coordinated spatial reuse (Co-SR), or a coordinated time-division multiple access (Co-TDMA).

2. The method of claim 1, wherein the coordinate information is carried by the negotiation request frame.

3. The method of claim 1, wherein an initiating AP or a response AP is configured to update or teardown a MAPC agreement.

4. The method of claim 1, wherein performing the coordinated transmission operation comprises: an initiating AP transmitting a medium access control (MAC) frame, and the MAC frame comprises information with at least one of the followings:
a transmission opportunity (TXOP) to be shared with the at least one other AP device;
a channel bandwidth used for downlink transmission to one or more associated non-AP stations; or
a number of spatial streams or transmit chains to be used for coordinated beamforming.

5. The method of claim 1, wherein performing the coordinated transmission operation comprises: an initiating AP transmitting a trigger frame to trigger a physical layer protocol data unit (PPDU) transmission using a channel bandwidth associated with the AP device.

6. The method of claim 1, wherein performing the coordinated transmission operation comprises: an initiating AP transmitting a null data packet announcement (NDPA) frame to trigger a unified sounding procedure for measuring channel state information (CSI) for both the AP device and the at least one other AP device.

7. The method of claim 6, wherein during the unified sounding procedure, the AP device transmits a first null data packet (NDP) using a first number of transmit chains and receives a second NDP transmitted using a second number of transmit chains.

8. The method of claim 5, wherein a response AP device adapts the channel bandwidth of an initiating AP, or adapts an unequal channel bandwidth of the initiating AP.

9. The method of claim 1, wherein the coordinated transmission operation comprises enabling at least one station associated with the AP device to perform opportunistic path-loss measurements of signals transmitted by the at least one other AP device.

10. The method of claim 9, wherein the AP device transmits a trigger frame or a NDPA frame containing an indication of transmit power to support the opportunistic path-loss measurements.

11. The method of claim 1, wherein the coordination information comprises initiating a multi-AP coordination (MAPC) negotiation including an indication of symmetrical or asymmetrical operation.

12. The method of claim 11, wherein the coordination information comprises an indication requesting the at least one other AP device to operate as a synchronization follower or synchronization reference.

13. The method of claim 12, wherein the synchronization follower compensates a carrier frequency offset (CFO) based on the synchronization reference.

14. The method of claim 1, wherein performing the coordinated transmission operation comprises determining a reference AP device based on which AP device obtains a TXOP.

15. The method of claim 3, further comprising transmitting a termination indication to release roles or identifiers associated with a terminated MAPC agreement.

16. The method of claim 1, wherein the AP device transmits a trigger frame to initiate physical layer protocol data unit (PPDU) transmission in response to receiving an acceptance indication from the at least one other AP device.

17. The method of claim 1, wherein performing the coordinated transmission operation comprises transmitting an initial control frame (ICF) to associated stations.

18. A method of coordinated operation performed by an access point (AP) device, comprising:
receiving, from another AP device, a negotiation information for multi-AP coordination (MAPC); and
transmitting, to the another AP device, a response indicating at least one configuration for coordinated beamforming or coordinated spatial reuse.

19. An AP device, comprising:
a memory;
a transceiver; and
a processor coupled to the memory and the transceiver;
wherein the transceiver is configured to transmit, to at least one other AP device, coordinate information or a negotiation request frame for multi-AP coordination (MAPC); and
wherein the processor is configured to perform, based on a response from the at least one other AP device, a coordinated transmission operation, wherein the coordinated transmission operation comprises at least one of a coordinated beamforming (Co-BF), a coordinated spatial reuse (Co-SR), or a coordinated time-division multiple access (Co-TDMA).
